(19) United States
(12) Patent Application Publication
(10) Pub. No.: US 2010/0199447 A1
(43) Pub. Date: Aug. 12, 2010

(54) CLEANER GUIDE FOR CLEANING BACKPLANE OPTICAL CONNECTORS

(75) Inventor: Stanley A. Mercado, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: TASEON INC., San Jose, CA (US)

(21) Appl. No.: 12/368,193

(22) Filed: Feb. 9, 2009

(51) Int. Cl. B08B 9/00

(52) U.S. Cl. 15/104.001

(57) ABSTRACT

An apparatus for cleaning backplane optical connectors is described herein. According to one embodiment, an apparatus includes a cleaner guide having a frontend and a backend, where the cleaner guide has a cleaning channel extended from the frontend to the backend and the backend includes a mounting bracket for removably mounting a connector adapter. When the cleaner guide is inserted into a slot of the chassis, the connector adapter is aligned and engaged with an optical connector disposed on a backplane of the network chassis, such that a cleaner tool can be inserted from the frontend of the cleaner guide, through the cleaning channel, to reach the connector adapter of the backend for cleaning the optical connector, without having to remove an adjacent circuit pack of the network chassis. Other methods and apparatuses are also described.

### FIELD OF THE INVENTION

The present invention relates generally to optical networks. More particularly, this invention relates to a cleaner guide for cleaning backplane optical connectors.

### BACKGROUND

Fiber optic systems have been getting more popular recently. With the advent of light-wave technology, a large amount of information is capable of being transmitted, routed and disseminated across great distances at a high rate over communication lines made of optical fibers which are coupled with each other through optical connectors.

Dust, dirt and other contaminants are a problem in such optical connections because they interfere with the passage of light from one fiber to another. Fiber optic connectors must be kept clean to ensure long life and to minimize transmission loss and optical return loss at the connection point. A single dust particle caught between two connectors will cause significant signal loss.

Optical connectors on a backplane are difficult to clean for several reasons. One reason is because the equipment housing the backplane and optical connectors is generally placed against a wall making access to the rear of the optical connectors difficult. Also, the optical connectors are small and difficult to handle when removed for cleaning so it is advantageous to be able to leave them in the system and clean the optical connectors via front access to the shelf. Another reason is that cleaning the optical connectors via front creates the possibility of contact with other system components causing catastrophic failure of the system.

Conventional methods require the removal of adjacent circuit pack modules to create space for the operator to reach the optical connectors on the backplane. However, removal of adjacent circuit pack modules may prevent the system node from operating partially or even completely. In addition, removing, rotating, and replacing the cleaning adapters individually could be a cumbersome process if the backplane has many optical connectors.

There has been a lack of simple and reliable solutions for cleaning and inspecting optical connectors inside a backplane chassis where the connectors are not easily accessible, while allowing other components to continue operating.

### SUMMARY OF THE DESCRIPTION

An apparatus for cleaning backplane optical connectors is described herein. According to one embodiment, an apparatus includes a cleaner guide having a frontend and a backend, where the cleaner guide has a cleaning channel extended from the frontend to the backend and the backend includes a mounting bracket for removably mounting a connector adapter. When the cleaner guide is inserted into a slot of the chassis, the connector adapter is aligned and engaged with an optical connector disposed on a backplane of the network chassis, such that a cleaner tool can be inserted from the frontend of the cleaner guide, through the cleaning channel, to reach the connector adapter of the backend for cleaning the optical connector, without having to remove an adjacent circuit pack of the network chassis.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIGS. 1A-1G are diagrams illustrating a process for cleaning optical connectors of a backplane according to certain embodiments of the invention.

FIGS. 2A-2B show perspective views of a cleaner guide module according to one embodiment of the invention.

FIGS. 3A-3B show perspective views of a front panel of a cleaner guide according to one embodiment of the invention.

FIGS. 4A-4C show perspective views of side panels of a cleaner guide according to one embodiment of the invention.

FIGS. 5A-5B show perspective views of an alignment bracket of a cleaner guide according to one embodiment of the invention.

FIGS. 6A-6B show perspective views of a cleaner guide according to another embodiment of the invention.

FIGS. 7A-7B show perspective views of a front panel of a cleaner guide according to another embodiment of the invention.

FIGS. 8A-8D show perspective views of a side panel assembly according to another embodiment of the invention.

FIG. 9 shows a perspective view of an alignment bracket of a cleaner guide according to another embodiment of the invention.

FIGS. 10A-10B show perspective views of an optical connector adapter which may be used with one embodiment of the invention.

### DETAILED DESCRIPTION

A cleaner guide for cleaning backplane optical connectors is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

In most fiber systems, dust and other contaminants are not a major problem as long as the “light”, that is the optical signal, remains within the optical fiber. However, problems arise when the optical signal must pass from one fiber to another or where the optical signal must leave the fiber and enter a receiver or piece of test equipment, such as an optical power meter. The most common mechanical arrangement to allow light to travel from one fiber to another is an optical connector. Fiber optic connector systems are designed to align two fiber ends so that the light signal will pass between them.

Most connector systems restrain the two fibers to be coupled within precision ferrules, which in turn are held in place by a housing. Within the housing, a precision alignment sleeve aligns the two ferrules and thus the two fibers. The fiber ends are flush with the ferrule ends and are polished to reduce loss of light. All modern connector designs involve physical contact between the two fiber ends.

As mentioned above, dust, dirt and other contaminants are a problem in such optical connections because they interfere with the passage of light from one fiber to another. Fiber optic connectors must be kept clean to ensure long life and to minimize transmission loss and optical return loss at the connection point. A single dust particle caught between two connectors will cause significant signal loss.

In order to avoid problems and to keep fiber ends in peak condition, connector cleaning must be undertaken frequently. Inspection of the fiber end quality also needs to be undertaken to determine if cleaning is required or if the connector is seriously damaged.

The two basic approaches to cleaning are wet and dry cleaning. Wet cleaning utilizes a solvent such as Isopropyl Alcohol and fiber optic swabs. The swabs have a head made of a soft nonabrasive material that has low particle and fiber generation. Dry cleaning takes a number of forms, but the most common approach involves a special alcohol-free cloth or textile cleaning tape or film on a reel inside a cartridge. The cartridge stores the tape reel and provides a window onto a short portion of the cloth tape for cleaning the fiber ends of connectors. Also, a fiber optical swab with a sticky or tacky head may be used. Dynamic cleaning devices are also available which “spin” a cleaning cloth across the end of the fiber.

Microscopic inspection must be conducted to confirm that cleaning is successful. On some occasions, even after repeated cleaning, inspection will show that the fiber end is damaged beyond recovery and the connector must be replaced.

As mentioned above, optical connectors on a backplane are difficult to clean for several reasons. A backplane is an electronic circuit board containing circuitry and sockets into which additional electronic devices on other circuit boards or cards can be plugged. One reason is because the equipment housing the backplane and optical connectors is generally placed against a wall making access to the rear of the optical connectors difficult. Also, the optical connectors are small and difficult to handle when removed for cleaning so it is advantageous to be able to leave them in the system and clean the optical connectors via front access to the shelf. Another reason is that cleaning the optical connectors via front creates the possibility of contact with other system components causing catastrophic failure of the system. Another reason is that once the cleaning process is complete, all the fiber ends in the bundle must be clean. Furthermore, due to the small scale of the optical connector, finding the correct position for the cleaning swab or inspection scope while viewing the backplane from the front is very difficult.

Thus, the purpose of embodiments of the invention is to create an efficient solution for cleaning optical connectors mounted on a backplane of a chassis. The optical connectors are cleaned from the front of the chassis without having to remove adjacent circuit pack modules. Thus, it allows cleaning of the backplane optical connectors, one slot at a time, without having to completely shut down the corresponding system node (e.g., the chassis).

According to certain embodiments, to dry clean optical connectors in a backplane from the front of the chassis, a cleaner adapter needs to be installed into each optical connector. A cleaning ward of a cleaning tool is then inserted through the cleaning adapter and into the optical connector to clean the first set of ferrules (e.g., fibers) of the optical connectors. To clean the second set of ferrules of the optical connector, the cleaning adapter needs to be removed from the optical connector, then rotated in 180 degrees, and finally reinserted into the optical connector. The cleaning ward is then reinserted through the cleaning adapter and into the optical connector to clean the second set of ferrules.

Embodiments of the invention allow for a safe and efficient process for cleaning optical connectors. One advantage of embodiments of the invention is that cleaning could be performed without the removal of adjacent circuit packs. Another advantage is that it eases the process of installing the cleaning adapters. Such a design also provides safety to adjacent circuit packs during the cleaning process, such that the adjacent circuit packs would not be damaged during the cleaning process.

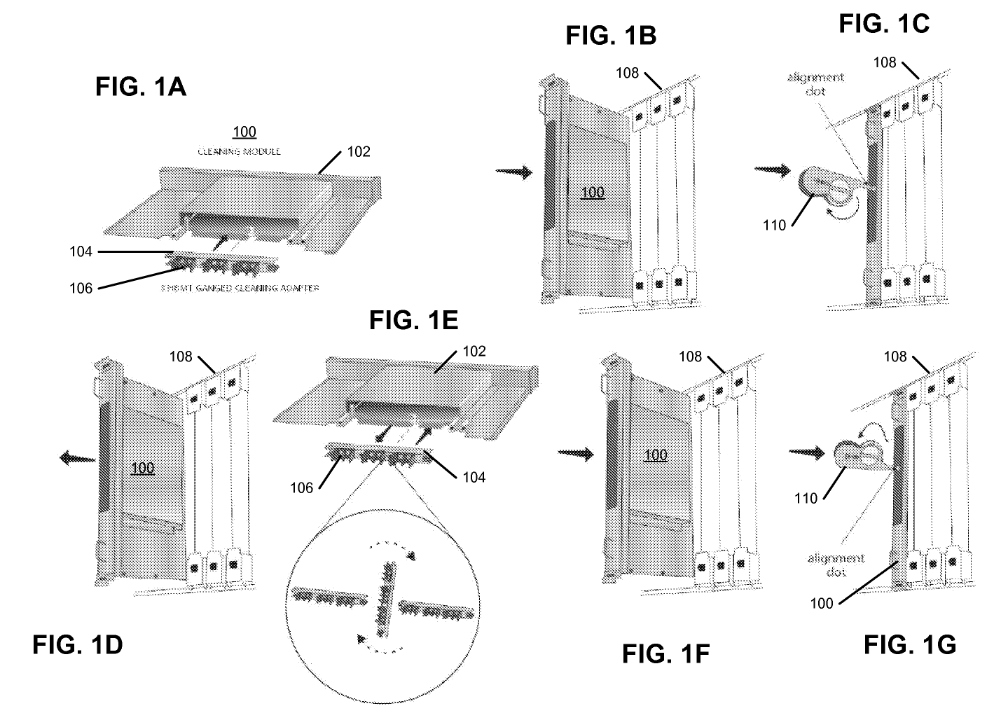

FIGS. 1A-1G are diagrams illustrating a process for cleaning optical connectors of a backplane according to certain embodiments of the invention. According to one embodiment, a cleaning module is designed to fit into a circuit pack module slot of a backplane chassis, where the cleaning module is designed to have a dimension similar to a regular circuit pack that can be inserted into any of slots of the backplane chassis. Referring to FIGS. 1A-1G, cleaning module 100 includes a cleaner guide module 102 having a removable an alignment bracket 104 with an optical connector adapter 106 mounted onto the alignment bracket 104. In this example, optical connector adapter 106 is an HBMT (high-density backplane mounted) compatible backplane connector. Note that for the purpose of illustration, an HBMT connector and an HBMT adapter are used as an example of an optical connector and adapter throughout this application. However, it is not so limited; other types of optical connectors and/or adapters can also be applied. Similarly, the techniques described throughout this application can also be applied to a variety of cleaning tools or methods (e.g., wet or dry cleaning methods) and the techniques can also be applied to a variety of backplane systems.

Referring back to FIGS. 1A-1G, cleaning module 100 can slide into chassis 108 just as any other circuit pack modules. This allows cleaning of the backplane HBMT connectors (not shown) disposed on a backplane of chassis 108, one slot at a time without having to remove adjacent circuit pack modules as shown in FIGS. 1B-1C. Cleaner guide module 102 includes a removable HBMT adapter 106 mounted on the alignment bracket 104. The HBMT adapter 106 may include a single HBMT adapter or multiple HBMT adapters (also referred to as a ganged HBMT adapter). Thus, there may be more than one ganged HBMT adapter per cleaning module, dependent upon number of HBMT connectors in the backplane per circuit pack.

In addition, dry cleaning of HBMT connectors requires the attachment of the HBMT cleaning adapter in two positions to clean both sets of optical fibers (e.g., ferrules of a connector). The two positions require a user to rotate the HBMT cleaning adapter 180 degrees around an axis of the HBMT connector. According to one embodiment, the design described throughout this application allows the HBMT cleaning adapter to be rotated 180 degrees to fulfill the required positions for multiple HBMT connectors per circuit pack slot as shown in FIGS. 1D-1G.

Once cleaning module 100 is inserted into chassis 108 with appropriate HBMT cleaning adapter 106 mounted via alignment bracket 104 in an appropriate orientation, a dry cleaner wand of a dry cleaner 110 can be inserted from a front panel of chassis 108, through cleaning module 100, to reach the HBMT connectors (not shown) mounted on a backplane of chassis 108 for cleaning, where ferrules of the HBMT connectors are maintained opened by HBMT adapters 106 which are aligned by alignment bracket 104, as shown in FIG. 1C and 1G.

According to another embodiment, cleaning module 100 can also be used for wet cleaner and optical inspection probes. In such situation, cleaning module 100 can simply inserted without the HBMT adapters and/or the alignment bracket mounted thereon. A wet cleaner and an optical inspection probe can be inserted through the cleaner module to reach the HBMT connectors mounted on the backplane.

Further, according to one embodiment, cleaner module 100 further includes side panels to form a tunnel or channel to allow a cleaner or inspection probe to be inserted therein. The side panels also serve a protection purpose such that during the cleaning or inspection process, adjacent circuit packs would not be accidentally contacted (e.g., short circuit).

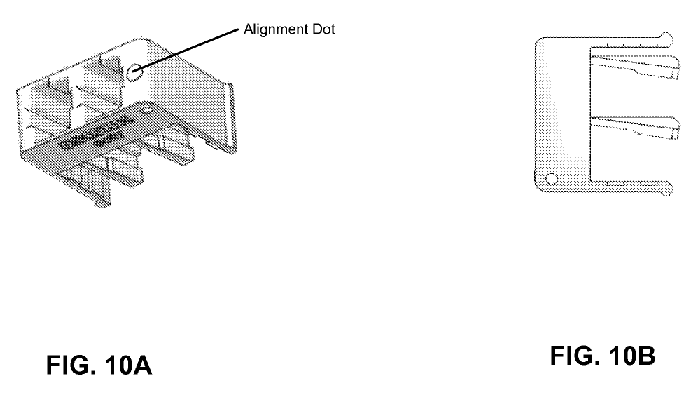

Before cleaning the HBMT connectors of a particular circuit slot of a chassis, the corresponding circuit pack of the particular circuit slot is removed from the chassis. An HBMT adapter 106 is attached to an alignment bracket 104 and the alignment bracket 104 having HBMT adapter 106 attached thereon is then inserted into cleaner guide module 102, forming a cleaning module 100, as shown in FIG. 1A. The assembled cleaning module 100 is then inserted into the slot to be cleaned as shown in FIG. 1B. Thereafter, a nose of a cleaner 110 can then be inserted through the tunnel of the cleaning module 100 to reach the HBMT connectors mounted on a backplane of chassis 108 for the cleaning purpose as shown in FIG. 1C. In order to ensure that cleaner 110 is positioned properly, an alignment dot on top of the cleaner 110 is in line with an alignment dot on the HBMT adapter as shown in FIG. 10A.

Once the first set of ferrules of an HBMT connector has been clean, cleaning module 100 is removed from the slot as shown in FIG. 1D and the HBMT adapters 106 as well as the alignment bracket 104 is rotated in 180 degrees with respect to the cleaner guide 102 as shown in FIG. 1E. Thereafter, the cleaning module 100 with the rotated adapters is inserted back to the slot as shown in FIG. 1F and the cleaner 110 can then be reinserted into the cleaning module to clean a second set of ferrules of HBMT connectors as shown in FIG. 1G. The above process can be repeated for each of the slots in the chassis.

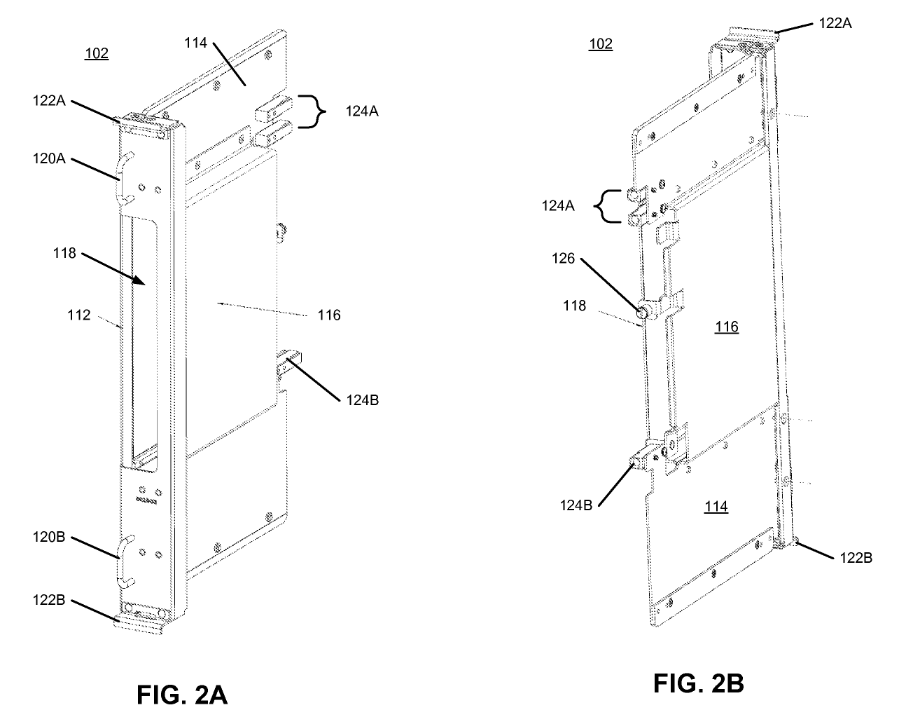

FIGS. 2A-2B show perspective views of a cleaner guide module according to one embodiment of the invention. Referring to FIGS. 2A-2B, cleaner guide module 102 may be utilized as part of a cleaner guide module of a cleaning module as shown in FIGS. 1A-1G. For the purpose of illustration, certain reference numbers are maintained the same for similar parts and/or similar functionality of the drawings. As described above, cleaner guide module 102 is configured to be in a similar dimension as an ordinary circuit pack which can be aligned and inserted into any one of the slots of a backplane chassis.

According to one embodiment, cleaner guide 102 includes a front panel 112, a first side panel 114, and a second side panel 116, which are mounted onto the front panel 112 via a pair of mounting brackets. Side panel 114 is a relatively flat panel while side panel 116 is in a U-shape form, which when attached onto side panel 114, forms a tunnel, in this example, a relatively rectangular tubular tunnel 118 which connects with an opening of front panel 112 with a back of cleaner guide 102. As described above, tunnel 118 may be used to insert a cleaning tool from a front panel 118 of cleaner guide to the backend of the cleaner guide in order to reach and clean the HBMT connectors of the backplane for the inspection and/or cleaning purpose.

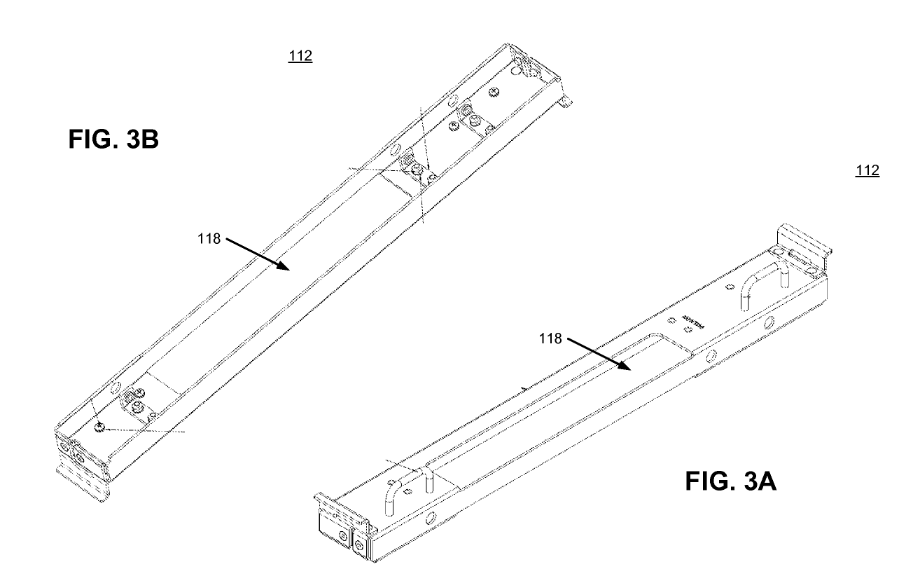

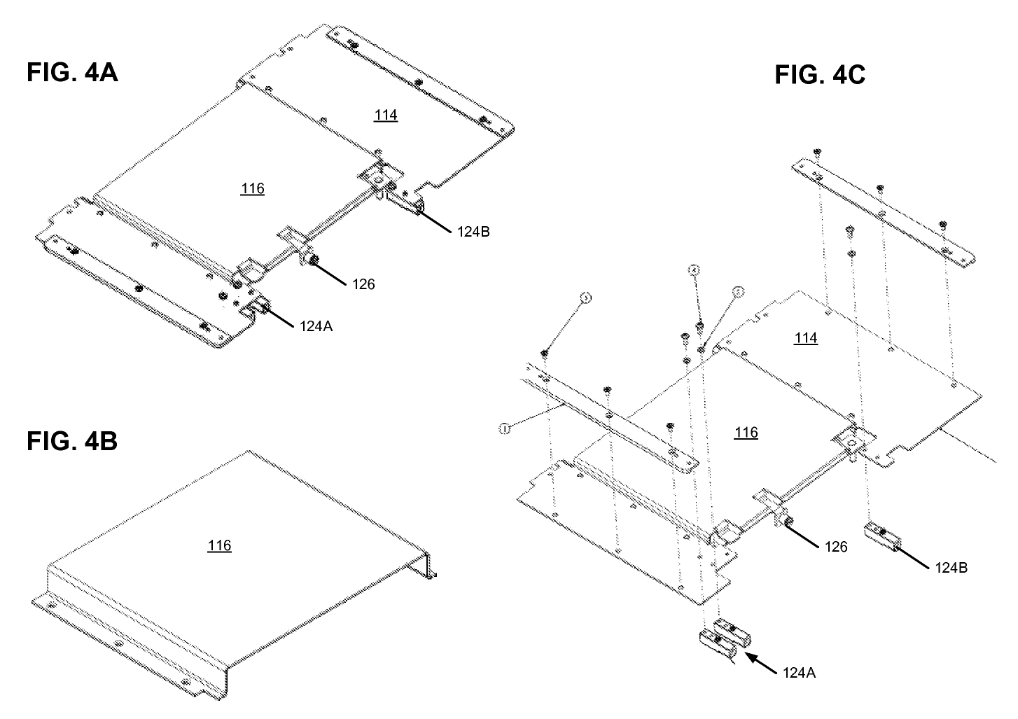

Front panel 112 includes one or more handles 120A-120B to allow a user to pull the cleaner guide 102 out from a slot of a backplane chassis. Front panel 112 further includes one or more stop brackets 122A-122B to stop the cleaner guide 102 from being overly pushed into a slot of the backplane chassis. An enlarged version of front panel 112 is shown in FIGS. 3A-3B. An enlarged version of side panels 114 and 116 are shown in FIGS. 4A-4C.

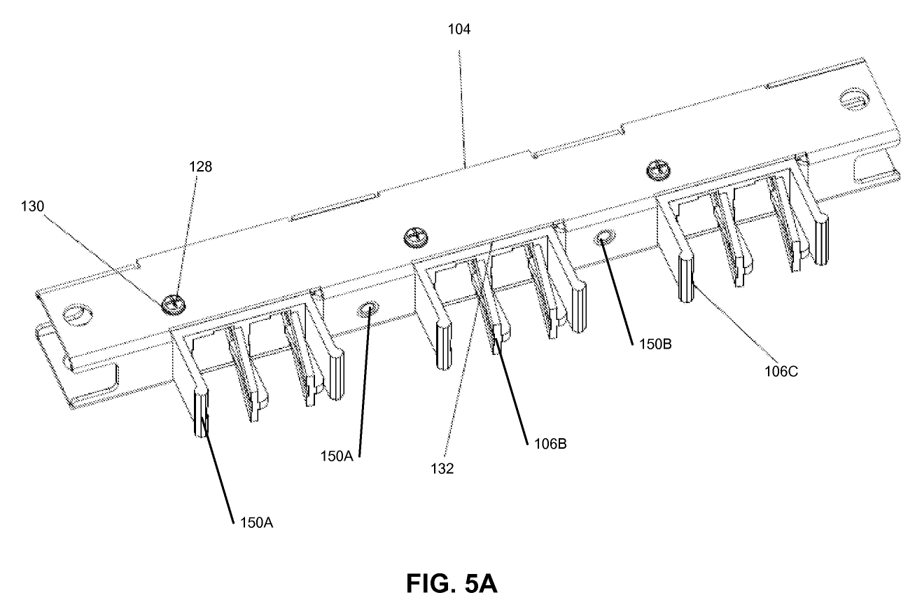

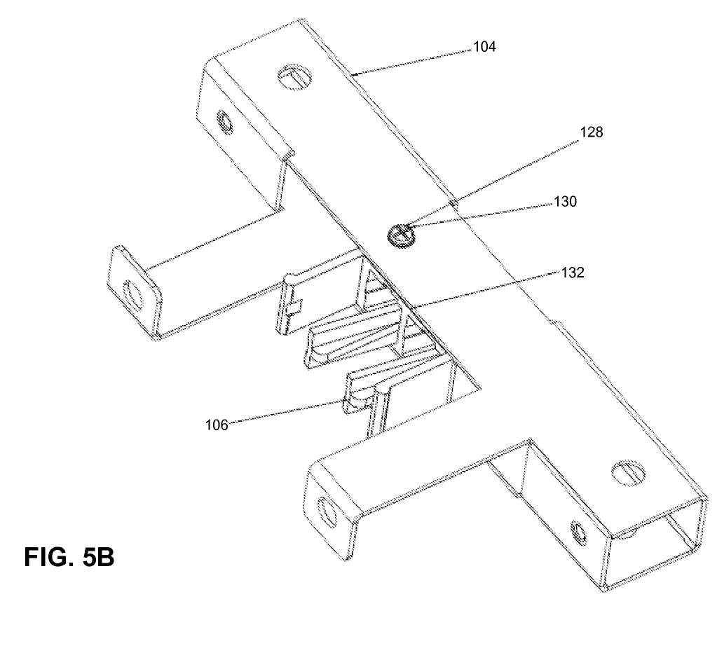

Referring back to FIGS. 2A-2B, according to one embodiment, cleaner guide 102 further includes a cutout formed on a backend of cleaner guide 102 to form a backend of tunnel 118. The cutout is also utilized to receive an alignment bracket having one or more HBMT adapters attached thereon, as shown in FIGS. 5A-5B. The alignment bracket having the HBMT adapters may be mounted within the cutout via a mounting bracket 126 extended from side panel 116. The mounting bracket 126 further includes a screw which can engage with a threaded slot disposed on the alignment bracket (not shown) to secure the alignment bracket onto cleaner guide 102.

In one embodiment, cleaner guide 102 further includes one or more alignment slots 124A-124B mounted on a backend of cleaner guide 102. In this embodiment, alignment slots 124A-124B are mounted on a backend of side panel 114. When cleaner guide 102 is inserted to a circuit slot of a backplane chassis, the alignment slots 124A-124B are aligned with corresponding alignment pins (not shown) mounted on a backplane of the chassis. In this way, the HBMT adapters along with the alignment bracket can be precisely aligned with the corresponding HBMT connectors mounted on the backplane of the chassis.

FIGS. 5A-5B show perspective views of an alignment bracket according to certain embodiments of the invention. Specifically, FIG. 5A shows an alignment bracket capable of mounting multiple HBMT adapters, in this example, three adapters, while FIG. 5B shows an alignment bracket having a single HBMT adapter. However, it is important to note that fewer or more HBMT adapters may be implemented in an alignment bracket. Referring to FIGS. 5A-5B, alignment bracket 104 includes multiple opening or slots for mounting HBMT adapters 106A-106C. Each adapter is aligned with an edge 132 of a corresponding opening and mounted using a screw 128 via a mounting hole 130 of cleaner guide 104 into a corresponding threaded slot (not shown) of the corresponding adapter. An HBMT adapter, which is shown in an enlarged version in FIGS. 10A-10B, can be inserted into an HBMT connector to ensure that ferrules of the HBMT connector are open enough to allow a cleaning tool to clean the ferrules (e.g., fibers) of the HBMT connectors. The alignment bracket 104 further includes one or more mounting holes 150A-150B to allow a mounting screw 126 of cleaner guide 102 of FIGS. 2A-2B to secure the alignment bracket 104 onto the cleaner guide 102. Note that only one of the mounting holes may be used at a time dependent upon how the alignment bracket 104 is positioned, for example, before or after rotation of 180 degrees for the purpose of cleaning different sets of ferrules of an optical connector.

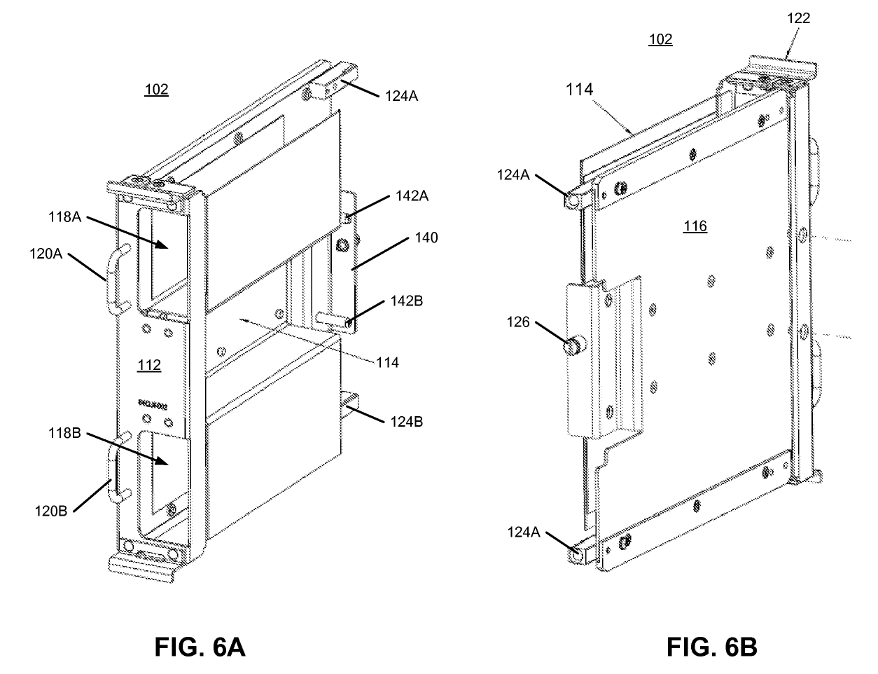

FIGS. 6A-6B show perspective views of a cleaner guide according to another embodiment of the invention. Referring to FIGS. 6A-6B, similar to the one shown in FIGS. 2A-2B, cleaner guide 102 includes a front panel 112 and side panels 114 and 116. The cleaner guide 102 is designed to have a dimension similar to an ordinary circuit pack that can be inserted into any one of slots of a backplane chassis, such as chassis 108 as shown in FIGS. 1A-1G. Again for the purpose of illustration, certain reference numbers for similar parts and/or similar functionality are maintained the same.

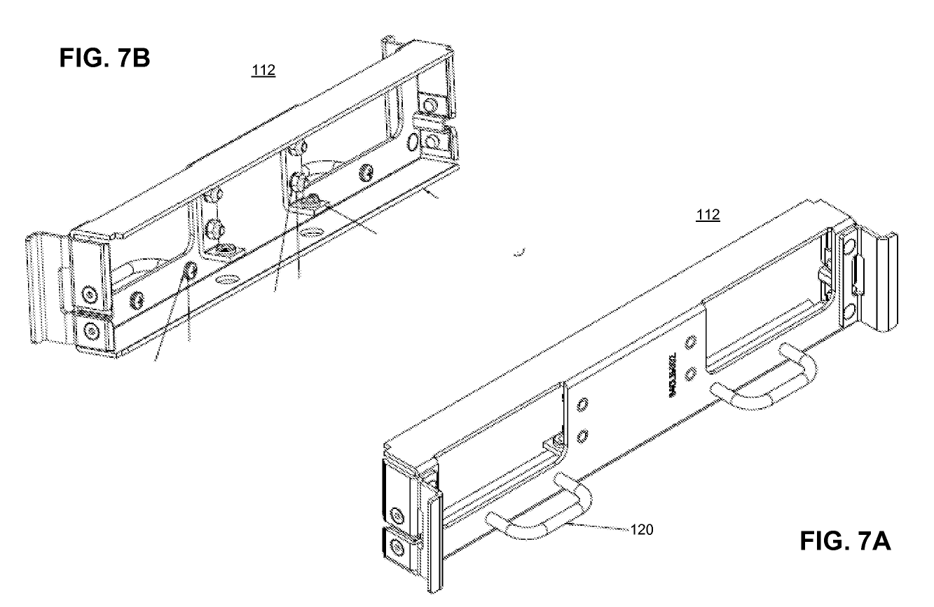

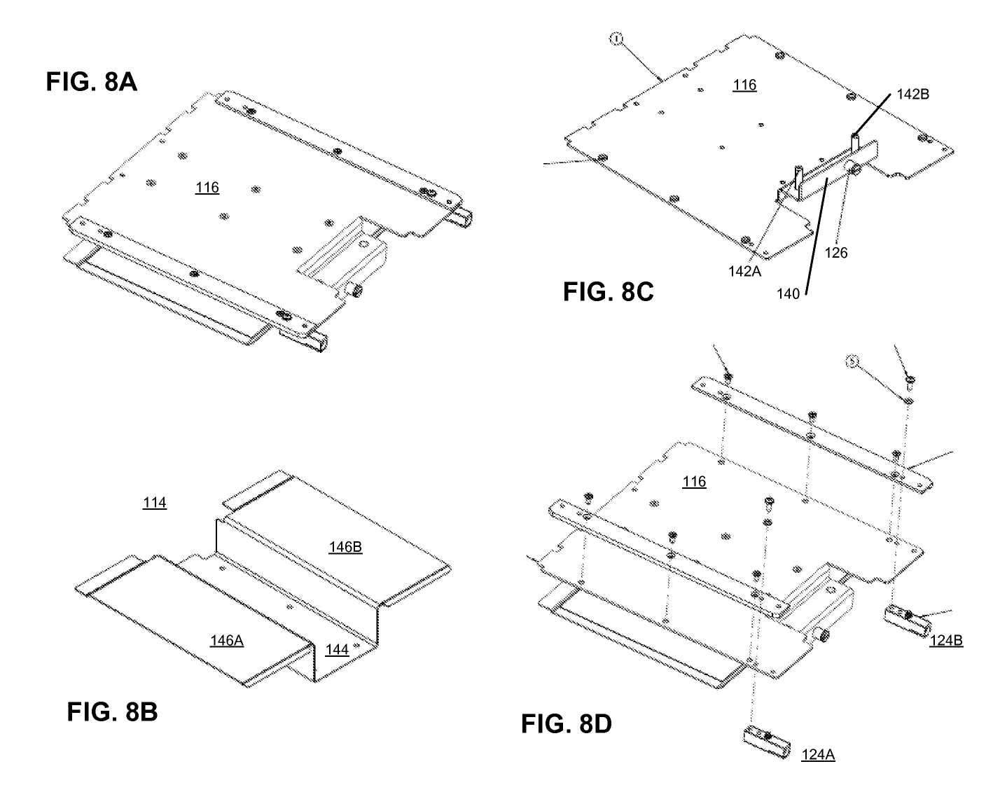

In this embodiment, side panel 114 is formed in a relatively U-shape having a center piece and two wing pieces as shown in FIG. 8D. However, unlike the side panel 114 as shown in FIGS. 2A-2B in which the panel is mounted with side panel 116 via the wing pieces, in this embodiment as shown in FIGS. 6A-6B, the side panel 114 is mounted onto side panel 116 via the center piece. As a result, the wing pieces of side panel 114 together with side panel 116 form two separate tunnels 118A and 118B. The side panels 114 and 116 are mounted with a front panel 112 through a pair of mounting brackets as shown in FIGS. 7A-7B.

FIGS. 8A-8D show perspective views of a side panel assembly according to one embodiment of the invention. Specifically, FIG. 8A shows a bottom perspective view of side panel 116; FIG. 8B shows a top perspective view of side panel 116; and FIG. 8D shows side panel 116 being assembled. FIG. 8D shows a perspective view of side panel 114. Referring to FIGS. 8A-8D, side panel 114 includes a center piece 144 and two wing pieces 146A-146B. Center piece 144 includes one or more mounting holes that can be used to mount the side panel 114 onto a top surface of side panel 116 as shown in FIG. 8B using one or more screws. As a result, the wing pieces 146A- 146B together with side panel 116 form two cleaning tunnels 118A-118B separated by center piece 114.

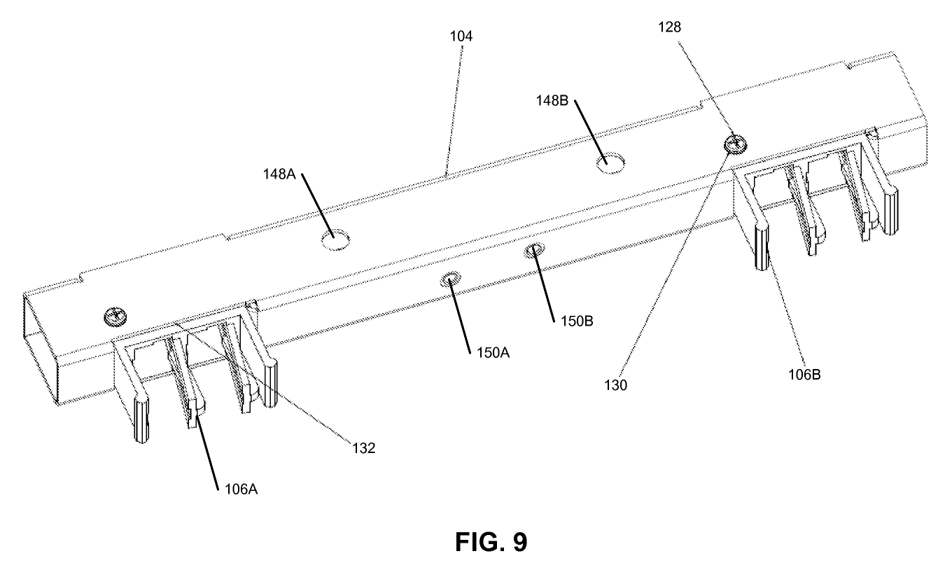

In addition, according to one embodiment, a portion of a backend of side panel 116 is bent or folded inwardly to form a mounting fixture or mounting bracket 140 for mounting an alignment bracket with one or more HBMT adapters such as one shown in FIG. 9. Mounting bracket 140 further includes one or more alignment pins 142A-142B disposed thereon to align an alignment bracket with the HBMT adapters mounted thereon. The alignment bracket can then be secured onto side panel 116 using screw 126.

FIG. 9 shows a perspective view of an alignment bracket having HBMT adapters mounted thereon according to another embodiment of the invention. Referring to FIG. 9, alignment bracket 104 includes two opening having two HBMT adapters 106A-106B mounted via screw 128 through mounting hole 130 and aligned with an edge 132 of the alignment bracket 104. Alignment bracket 104 further includes two mounting holes 150A-150B that allow screw 126 of cleaner guide of FIGS. 6A-6B to secure the alignment bracket 104 onto the cleaner guide 102. Note that only one of the mounting holes 150A-150B is used at a time dependent upon which orientation the alignment bracket 104 is positioned (e.g., before or after rotation of the alignment bracket in 180 degrees) for the purpose of cleaning different sets of ferrules of an optical connector. The alignment bracket 104 further includes one or more alignment slots 148A-148B to align the bracket with the alignment pins 142A-142B of FIGS. 6A-6B. HBMT adapters 106A-106B could be any kind of HBMT adapters, such as those shown in FIGS. 10A-10B.

Thus, a cleaner guide for cleaning backplane optical connectors has been described herein. In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An apparatus for cleaning backplane optical connectors, the apparatus comprising:
a cleaner guide having a frontend and a backend, the cleaner guide having a cleaning channel extended from the frontend to the backend, the backend including a mounting bracket for removably mounting a connector adapter,
wherein when the cleaner guide is inserted into a slot of the chassis, the connector adapter is aligned and engaged with an optical connector disposed on a backplane of the network chassis, such that a cleaner tool can be inserted from the frontend of the cleaner guide, through the cleaning channel, to reach the connector adapter of the backend for cleaning the optical connector, without having to remove an adjacent circuit pack of the network chassis.

2. The apparatus of claim 1, wherein the cleaner guide has a physical dimension similar to a regular circuit pack that can be inserted any one of a plurality of slots of a network chassis.

3. The apparatus of claim 1, wherein the cleaning channel is formed as a tunnel having a surrounding wall to insulate the adjacent circuit pack, such that the cleaning tool does not contact the adjacent circuit pack while being inserted through the tunnel.

4. The apparatus of claim 1, further comprising a removable alignment bracket disposed on the backend of the clean guide for aligning the connector adapter with the optical connector of the backplane, wherein the connector adapter is attached to the alignment bracket, and wherein the alignment bracket having the connector adapter attached therein is then mounted on the mounting bracket of the backend of the cleaner guide.

5. The apparatus of claim 4, wherein when the alignment bracket is mounted in a first orientation on the backend of the cleaner guide, the cleaning tool can be inserted through the connector adapter to clean a first set of ferrules of the optical connector, and wherein when the alignment bracket is mounted in a second orientation on the backend of the cleaner guide, the cleaning tool can be inserted through the connector adapter to clean a second set of ferrules of the optical connector.

6. The apparatus of claim 5, wherein after the first set of ferrules of the optical connector has been cleaned, the cleaner guide along with the alignment bracket can be removed from the slot and the alignment bracket can be positioned from the first orientation to the second orientation, and wherein the cleaner guide having the alignment bracket positioned in the second orientation can be reinserted into the slot to enable the cleaning tool to be reinserted through the cleaning channel to clean the second set of ferrules of the optical connector.

7. The apparatus of claim 4, wherein the cleaner guide comprises:
a front panel having an opening aligned with a frontend of the cleaning channel;
a first side panel having a frontend attached to the front panel; and
a second side panel having a frontend attached to the front panel, the first and second side panels coupled with each other to form the cleaning channel, wherein the removable alignment bracket is mounted on a backend of at least one of the first and second side panels.

8. The apparatus of claim 7, wherein the connector adapter is mounted on the removable alignment bracket in a manner such that the connector adapter is accessible by the cleaning tool from the opening of the front panel through the cleaning channel.

9. The apparatus of claim 7, wherein the first side panel is a relatively flat panel and the second side panel is molded in a U-shape panel, wherein the U-shape panel and the flat panel when attached to each other form a tunnel as part of the cleaning channel.

10. The apparatus of claim 9, wherein the U-shape panel includes a center piece and a first and second wing piece, wherein the U-shape panel is attached to the first side panel via the wing pieces, forming the tunnel centrally located on the first side panel.

11. The apparatus of claim 9, wherein the U-shape panel includes a center piece and a first and second wing piece, wherein the U-shape panel is attached to the first side panel via the center piece, forming a first tunnel and a second tunnel on opposite sides of the first side panel, and wherein the connector adapter includes a first connector adapter mounted on a backend of the first tunnel and a second connector adapter mounted on a backend of the second tunnel.

12. The apparatus of claim 9, further comprising one or more alignment slots mounted on a backend of the first side panel, wherein when the cleaner guide is inserted into the slot, the one or more alignment slots are aligned with corresponding alignment pins mounted on the backplane of the chassis, such that the connector adapter is aligned with the optical connector of the backplane.

13. The apparatus of claim 4, wherein the cleaning tool is a dry cleaning tool, wherein when the removable alignment bracket and the connector adapter are removed, at least one of a wet cleaning tool and an inspection tool can be inserted from the frontend of the cleaner guide, through the cleaning channel, to reach the optical connector of the backplane for cleaning or inspection purpose.

14. The apparatus of claim 4, wherein the connector adapter is a ganged connector adapter having a plurality of individual connector adapter corresponding to ganged optical connectors mounted on the backplane of the chassis.

15. A cleaner guide for cleaning backplane optical connectors, the cleaner guide comprising:
a front panel having an opening;
a first side panel mounted onto the front panel; and
a second side panel mounted on the front panel, the second side panel molded in a U-shape form attached to a surface of a first side panel, forming a tubular tunnel having a frontend aligned with the opening of the front panel and a backend to be coupled to one or more connector adapters,
wherein the cleaner guide has a physical dimension similar to a regular circuit pack that can be inserted into any one of a plurality of slots of a network chassis, and
wherein when the cleaner guide is inserted to a slot of the network chassis, the one or more connector adapters are coupled and aligned with corresponding optical connectors disposed on a backplane of the network chassis, such that a cleaner tool can be inserted from the opening of the front panel, through the tubular tunnel, to reach the one or more connector adapters of the backend for cleaning the optical connectors mounted on the backplane of the network chassis, without having to remove an adjacent circuit pack of the network chassis.

16. The cleaner guide of claim 15, wherein the tubular tunnel includes a surrounding wall to insulate adjacent circuit packs, such that when a cleaning tool is inserted through the tubular tunnel, the cleaning tool does not accidentally contact the adjacent circuit packs.

17. The cleaner guide of claim 15, further comprising a removable alignment bracket to align the one or more connector adapters with the optical connectors of the backplane, wherein the one or more connector adapters are attached to the removable alignment bracket and the removable alignment bracket is then removably mounted on the backend of the tubular tunnel.

18. A cleaner guide for cleaning backplane optical connectors, the cleaner guide comprising:
a front panel having a first opening and a second opening;
a first side panel mounted onto the front panel; and
a second side panel mounted on the front panel, the second side panel attached to a surface of a first side panel and molded in a manner to form a first tunnel and a second tunnel, each having a frontend aligned with one of the first and second openings of the front panel and a backend to be coupled to one or more connector adapters,
wherein the cleaner guide has a physical dimension similar to a regular circuit pack that can be inserted into any one of a plurality of slots of a network chassis, and
wherein when the cleaner guide is inserted to a slot of the network chassis, the one or more connector adapters are coupled and aligned with corresponding optical connectors disposed on a backplane of the network chassis, such that a cleaner tool can be inserted from at least one of the first and second openings of the front panel, through at least one of the first and second tunnels, to reach the one or more connector adapters of the backend for cleaning the optical connectors mounted on the backplane of the network chassis, without having to remove an adjacent circuit pack of the network chassis.

19. The cleaner guide of claim 18, wherein each of the first and second tunnels includes a surrounding wall to insulate adjacent circuit packs, such that when a cleaning tool is inserted through a respective tunnel, the cleaning tool does not accidentally contact the adjacent circuit packs.

20. The cleaner guide of claim 18, further comprising a removable alignment bracket to align the one or more connector adapters with the optical connectors of the backplane, wherein the one or more connector adapters are attached to the removable alignment bracket and the removable alignment bracket is then removably mounted on the backend of each tunnel.
